(19) United States
(12) Patent Application Publication
(10) Pub. No.: US 2025/0287289 A1
(43) Pub. Date: Sep. 11, 2025

(54) SYSTEM INFORMATION FOR ASSOCIATING A GROUP IDENTITY WITH NETWORKS

(71) Applicant: Telefonaktiebolaget LM Ericsson (publ), Stockholm (SE)

(72) Inventors: Christofer LINDHEIMER, Vadstena (SE); Mai-Anh PHAN, Herzogenrath (DE); Oscar OHLSSON, Bromma (SE); Miguel Angel GARCIA MARTIN, Madrid (ES); Peter HEDMAN, Helsingborg (SE); Hernán Felipe ARRAÑO SCHARAGER, Täby (SE)

(21) Appl. No.: 18/283,622

(22) PCT Filed: Mar. 23, 2022
(86) PCT No.: PCT/SE2022/050275

§ 371 Date: Sep. 22, 2023

Related U.S. Application Data
(60) Provisional application No. 63/164,595, filed on Mar. 23, 2021.

(51) Int. Cl. H04W 48/10; H04W 48/18

(52) U.S. Cl. CPC H04W 48/10; H04W 48/18

(57) ABSTRACT

Embodiments herein relate to, for example, a method performed by a radio network node for handling communication in a wireless communications network. The radio network node transmits system information including an association parameter associating a GID with one or more networks in the SI.

### TECHNICAL FIELD

Embodiments herein relate to a radio network node, a user equipment (UE) and methods performed therein regarding wireless communication. Furthermore, a computer program product and a computer-readable storage medium are also provided herein. In particular, embodiments herein relate to handling communication, such as handling or controlling access to a radio network node, e.g., a non-public network, in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node, e.g., a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and present and coming 3GPP releases, such as New Radio (NR) and extensions, are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

3GPP is currently working on Release 17 enhancements to first specifications of the 5G system of Release (Rel) 15 and/or 16. These types of enhancements are made to functionality that was introduced in early releases of the 5G specification.

One such functionality is Non-Public Networks, also known as NPNs, that was introduced in Rel 16.

3GPP introduced support for two non-public networks deployment options from Rel 16. The first NPN option outlines how operators could support non-public networks or dedicated deployments by associating them directly to the operator network. Such improvements resulted in solutions for what is commonly referred to as Public Network Integrated (PNI) NPNs.

An important aspect of a PNI-NPN is a mechanism for preventing foreign UEs, e.g., UEs that are not authorized nor members of the PNI-NPN, to register and use the resources of the PNI-NPN. This includes the ability of the PNI-NPN for using exclusive radio cells devoted to provide services to their UE members.

The next generation (NG)-RAN of PNI NPN is realized through a mechanism known as Closed Access Group (CAG) wherein a CAG identity (ID) is broadcasted in a cell and where only members of the CAG are allowed access to the cell. For this reason, a PNI NPN cell can also be referred to as a CAG cell. Members of the PNI-NPN are provisioned in their subscription data with a list of CAG IDs representing the cells that these UEs can use to register in the PNI-NPN. An additional flag, in the UE subscription data too, determines whether the UE can only access the 5G system via CAG cells.

Another NPN option is the stand-alone NPN, or SNPN for short. In almost all aspects, this is a network that carries the same functionality and characteristics as the more commonly known Public Land Mobile Network (PLMN), but it differs in some aspects, e.g., an SNPN is identified by an SNPN ID rather than a PLMN ID. The SNPN ID is composed of a PLMN ID and a Network ID (NID). Additionally, there is no support for mobility between SNPNs, in the same way as is possible between, equivalent, PLMNs.

In a cell, here understood as an entity that sends a broadcast, e.g., system information block one (SIB1) message, there can be one or many NPNs or PLMNs sharing the resources, e.g., frequency and processing capabilities, and such situations are commonly referred to as RAN sharing.

One and the same SIB broadcast can thus represent different networks and for each of these, there can be specific identifiers such as Cell IDs, i.e., different “logical” cells, and different Tracking Area Codes (TAC).

To account also for sharing between PLMNs and NPNs, between PLMNs only or between NPNs only, two different lists have been defined in the broadcast, one for listing NPNs, comprising both SNPNs and CAG cells, referred to as npn-IdentityInfoList and one for listing PLMNs, referred to as plmn-IdentityList, see below.

These lists are defined in 3GPP Technical Specification (TS) 38.331 [2] and are broadcast in SIB1.

-- ASN1START
-- TAG-CELLACCESSRELATEDINFO-START

| CellAccessRelatedInfo ::= | SEQUENCE { | |
|---|---|---|
| plmn-IdentityList | PLMN-IdentityInfoList, | |
| cellReservedForOtherUse | ENUMERATED {true} | OPTIONAL, -- Need R |

```
  ...,
  [[
```

| | | |
|---|---|---|
| cellReservedForFutureUse-r16 | ENUMERATED {true} | OPTIONAL, -- Need |
| npn-IdentityInfoList-r16 | NPN-IdentityInfoList-r16 | OPTIONAL -- Need R |

]]
}
-- TAG-CELLACCESSRELATEDINFO-STOP
-- ASN1STOP

Abstract Syntax Notation (ASN; ASN1; ASN.1) used herein, e.g., as code snippets, describes what information is/may be communicated in each referenced scenario.

The different lists allow an operator, PLMN-specific or, e.g., neutral host operator, to support a number of different PLMNs and NPNs in the broadcast.

An NPN, identified by a PLMN ID+CAG ID or a SNPN ID, can further be associated with Human Readable Network Name (HRNN) to facilitate manual network selection. According to this manual mode of operation, the UE retrieves the available HRNNs from SIB, renders to the user, which manually selects one of the displayed HRNN. Then the UE selects the NPN associated to this HRNN.

This HRNN is broadcast in a separate SIB, such as SIB10.

The below is the ASN.1 for SIB10, including an HRNN list.

SIB10 information element

```
  -- ASN1START
  -- TAG-SIB10-START
```

| SIB10-r16 ::= | SEQUENCE { | |
|---|---|---|
| hrnn-List-r16 | HRNN-List-r16 | OPTIONAL, -- Need R |
| lateNonCriticalExtension | OCTET STRING | OPTIONAL, |

```
    ...
  }
```

| HRNN-List-r16 ::= | SEQUENCE (SIZE (1..maxNPN-r16)) OF HRNN-r16 | |
|---|---|---|
| HRNN-r16 ::= | SEQUENCE { | |
| hrnn-r16 | OCTET STRING (SIZE (1.. maxHRNN-Len-r16)) | OPTIONAL |

```
-- Need R
  }
  -- TAG-SIB10-STOP
  -- ASN1STOP
```

SIB10 field descriptions

HRNN-List
The same amount of HRNN elements as the number of NPNs in SIB 1 are
included. The n-th entry of HRNN-List contains the human readable network name of the
n-th NPN of SIB1. The hrnn in the corresponding entry in HRNN-List is absent if there is no
HRNN associated with the given NPN.

For NPN, the enhancements currently addressed are described in 3GPP Technical Report (TR) 23.700-07 [1], which is a technical report outlining a number of key issues, which can be translated into enhancement areas.

Key issue (KI) #1 describes a situation when a UE can access an SNPN using credentials not from the SNPN itself, but from another, separate entity, which can be another Service Provider (SP), or Subscription Provider. System Architecture (SA) 2 decided at a later stage to refer to the separate entity as Credentials Holder (CH).

The challenges related to KI #1 are described in TR 23.700-07 [1] as:

“This key issue aims at addressing the following points for SNPN along with subscription owned by an entity separate from the SNPN:
How to identify the separate entity providing the subscription.
Network selection enhancements, including UEs with multiple subscriptions;
E.g. how does the UE discover and select an SNPN which provides authentication in an external entity;
Architecture enhancements needed to support multiple separate entities, e.g.:
What are the interfaces exposed and/or used by SNPN and the separate entity;
What is the architecture and solution for a UE accessing a separate entity via SNPN access network;
How to exchange authentication signalling between the SNPN and the separate entity, including:
Authentication by the PLMN, based on PLMN identities and credentials, for access to the SNPN;
Authentication via SNPN to separate entity based on non-3GPP identities (e.g. non-IMSI) and credentials;
Mobility scenarios, including service continuity, for:
UE moving from SNPN #1 with separate entity #1 to SNPN #2 with separate entity #1 available; and
UE moving between SNPN #1 (where separate entity=PLMN) and PLMN.

NOTE: Security aspects should be defined by SA WG3.”

3GPP TR 23.700-07 [1] indicates the following relevant conclusions for KI #1:
Group ID as a specific case of SNPN ID reusing SNPN ID encoding in TS 23.003, where
SIB will be enhanced as follows, for SNPN only:
Indication that “access using credentials from a separate entity is supported”
Optionally, supported Group Ids (GIDs)
Optionally, an indication whether the SNPN allows registration attempts from UEs that are not explicitly configured to select the SNPN

In the following, above conclusions for KI #1 are explained.

In order for a UE to discover and select an SNPN which provides authentication in an external entity, i.e., the SP, TR 23.700-07 [1] concludes that SNPNs need to indicate these new functionalities to UEs. Otherwise, the UEs would not know that they can access these networks with the credentials they obtain from the SP.

Furthermore, it was also concluded to allow an SNPN to indicate whether it allows registration attempts from UEs that are not explicitly configured to select this SNPN, hence enabling UEs to perform blind registration attempts, which eventually, may fail if the SNPN does not have means to authenticate the UE.

FIG. 1 shows an association between SNPN and (group of) SPs, the latter being identified by a group ID (GID).

It was concluded to introduce a GID, which provides the aggrupation of one or more SPs, to constitute an easy association between (the group of) SPs and SNPNs as illustrated in FIG. 1. It is mainly intended for the UE in network selection procedure and should associate the UE credentials from the SP with various SNPNs that support access using such credentials. At a later stage, this GID is referred to as “Group ID for network selection”, or GIN for short to be more specific what this GID is used for.

In this sense, and in specific cases where a SNPN does not hinder registration attempts from UEs that are not explicitly configured to select the network, then the use of GIDs could also reduce the number of opportunistic registration attempts. The thinking behind the GID or GIN is that it would be easier to handle changing support for access of a certain SP, or that it would be easier also for SNPNs to advertise what SPs are supported, especially in scenarios in which the number of these is large. Thus, the GID is bridging the association between SNPNs and service providers in a many-to-many possible relationship that can change without the need to change the UE configuration which would list all the SNPNs supporting access using credentials from any of the SPs identified by the GID.

In summary, the GIN is an identifier of a collection of SPs.

The use of GIDs is exemplified as follows:

“Home SP Group examples include:
National operating companies of a multi-national operator
By broadcasting the Home SP Group ID assigned to the multi-national operator, a Visited (V)-SNPN can enable the UEs from all the national operating companies of the multi-national operator to select the V-SNPN (instead of having to broadcast the Home SP IDs of each of the national operating companies, which may also exceed the number of Home SP IDs supported by SIB).
Home SPs that are connected to an interconnection provider
Typically mobile operators have direct interconnections and agreements only with large partner networks.
For the large amount of small partner networks, mobile operators typically use the services of an interconnection provider that provides interconnection with a large amount of partner networks while avoiding the need for bilateral agreements and interconnections.
By broadcasting the Home SP Group ID assigned to the interconnection provider, a V-SNPN can enable the UEs from all the Home SPs connected to the interconnection provider to select the V-SNPN (instead of having to broadcast the IDs of each of the Home SPs, which may also exceed the number of Home SP IDs supported by SIB) while also avoiding the need for the Home SPs to maintain an accurate list of all the supported V-SNPNs.

NOTE 1: The Home SP Group ID is assumed to be globally unique or self-managed. Assignment of a unique Home SP Group ID is beyond the scope of 3GPP.

The “Home SP” used in the referenced text above is herein referred to as SP and V-SNPN used in the text above is the visited network from the UE's or SP's point of view. It is generally referred to as SNPN herein. The “Home SP Group ID” used above is simply referred to as Group ID (GID).

As described in 3GPP TR 23.700-07 [1], clause 6.2.2.3, the Home SP Group IDs, i.e., the GIDs, are broadcast per SNPN:

“Next Generation (NG)-RAN nodes which support access using Home SP credentials broadcast the following information per SNPN: [ . . . ] List of supported Home SP Group IDs”

As mentioned above, the GID may identify one or multiple SPs and is used for initial registration and network selection. Since the GID is not needed for cell access, it is not considered an essential parameter.

In the 3GPP TR 23.700-07 [1], the following UE behavior is captured:
UE selects an available and allowable SNPN which broadcasts “access using credentials from a separate entity is supported” indication and a GID contained in the separate entity-controlled list (if available)

In other words, a UE that is equipped with credentials from a service provider that can be used to access certain SNPNs, is thus also configured with a GID. When the UE is moving around, and performing network selection, it can scan and detect available networks. The UE then detects SNPN ID(s) and GID(s) broadcast by the SNPN.

The UE decodes the available networks IDs in the cell from the npn-IdentityInfoLists and it also detects any list with GIDs and its association to these networks.

Now, the UE can, by comparing the GIDs it is configured with, with the GIDs broadcast by the SNPN, also detect which SNPNs are available for selection.

The UE network selection procedure would then select one of the SNPNs it is allowed to access, given the credentials and the GIDs the UE is configured with.

In the TR, the following is captured for manual selection:
For manual SNPN selection the UE presents all available SNPNs, which broadcast the “access using credentials from a separate entity is supported” indication.

It has also been proposed in 3GPP to broadcast a human readable name for the GIDs similar to HRNN used for NPNs. The human readable name for the GID, herein referred to as a Human Readable Group Name (HRGN), would be displayed to the user during the manual network selection so that the user can identify the group of SPs associated with an SNPN.

### SUMMARY

As part of developing embodiments here one or more problems were first identified. The main ambition with broadcast information is to keep it short and infrequent. Broadcasting a lot of information adds to the interference in the network and as such, directly impacts capacity that, otherwise, could be used to send user data. Since broadcast is generally always-on, and even if broadcast on-demand was configured, there are huge benefits in limiting the broadcast amount of data to the absolute minimum.

As described in 3GPP TR 23.700-07 [1], clause 6.2.2.3, the GIDs are supposed to be broadcast per SNPN. Using a simple approach may thus unnecessarily burden the broadcast. This could for example happen if multiple SNPNs in a shared network support the same GID and the system information broadcasts the same GID multiple times, i.e. once per SNPN supporting that GID. An object herein is to provide a mechanism to handle communication in an efficient and reliable manner in the wireless communications network.

According to an aspect the object is achieved, according to embodiments herein, by providing a method performed by a radio network node for handling communication in a wireless communications network. The radio network node transmits, e.g., broadcasts, a system information, wherein the system information comprises an association parameter associating a group identity with one or more networks in the system information.

According to an aspect the object is achieved, according to embodiments herein, by providing a method performed by a user equipment for handling communication in a wireless communications network. The user equipment receives a system information from a radio network node, wherein the system information comprises an association parameter associating a group identity, such as a GID or GIN mentioned above, with one or more networks, such as a NPN or a SNPN, in the system information.

According to an aspect the object is achieved, according to embodiments herein, by providing a radio network node and UE configured to perform the methods, respectively. Thus, it herein provided a radio network node for handling communication in a wireless communications network. The radio network node is configured to transmit, e.g. broadcast, a system information, wherein the system information comprises an association parameter associating a group identity with one or more networks in the system information. Furthermore, it is herein provided a user equipment for handling communication in a wireless communications network. The user equipment is configured to receive a system information from a radio network node, wherein the system information comprises an association parameter associating a group identity with one or more networks in the system information.

It is furthermore provided herein a computer program product comprising instructions, which, when executed on at least one processor, cause the at least one processor to carry out the method above, as performed by the radio network node and UE, respectively. It is additionally provided herein a computer-readable storage medium, having stored thereon a computer program product comprising instructions which, when executed on at least one processor, cause the at least one processor to carry out the method according to the method above, as performed by the UE or radio network node, respectively.

Embodiments herein disclose a solution that specifies a new association parameter. The association parameter associates a GID with one or more networks by, for example, referring to a bitmap or to a list of PLMNs and/or NPNs that are broadcast in SIB1. Group identity herein identifies a group of, or one or more, service providers. A list of GIDs and the corresponding association parameters may be transmitted together either in SIB1 or in a separate SIB. The latter is beneficial from an overhead perspective as it allows the GIDs and association parameters to be transmitted more infrequently at the cost of slightly longer acquisition time for the UE.

The association parameter may generally be used to describe any other type of relation between a network and a group of separate entities which have a relation to the UE trying to access that network.

Hence, embodiments herein provide a mechanism to efficiently transmit system information in the wireless communications network.

### BRIEF DESCRIPTION OF THE DRAWINGS

Embodiments will now be described in more detail in relation to the enclosed drawings, in which:

FIG. 1 shows an architecture according to prior art;

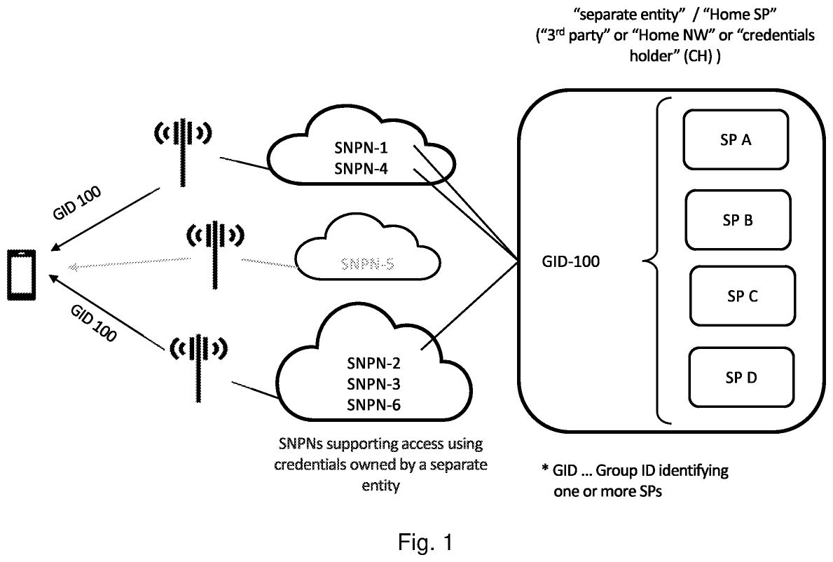

FIG. 2 shows a wireless communications network according to embodiments herein;

FIG. 3 shows a combined signalling scheme and flow chart according to embodiments herein;

FIG. 4 shows a flow chart depicting a method performed by a radio network node according to embodiments herein;

FIG. 5 shows a flow chart depicting a method performed by a user equipment according to embodiments herein;

FIG. 6 shows an exemplary 5G communication system comprising 5GC and NG-RAN;

FIG. 7 shows an association parameter according to embodiments herein;

FIG. 8 shows a schematic overview depicting a UE network selection behaviour based on GID broadcast according to embodiments herein;

FIG. 9 illustrates an association parameter according to embodiments herein;

FIG. 10 illustrates an association parameter according to embodiments herein;

FIG. 11 shows a schematic overview depicting a UE network selection behaviour based on GID broadcast according to embodiments herein;

FIG. 12 shows a block diagram depicting radio network nodes according to embodiments herein;

FIG. 13 shows a block diagram depicting network nodes according to embodiments herein;

FIG. 14 schematically illustrates a telecommunication network connected via an intermediate network to a host computer;

FIG. 15 is a generalized block diagram of a host computer communicating via a base station with a user equipment over a partially wireless connection; and

FIGS. 16-19 are flowcharts illustrating methods implemented in a communication system including a host computer, a base station and a user equipment.

### DETAILED DESCRIPTION

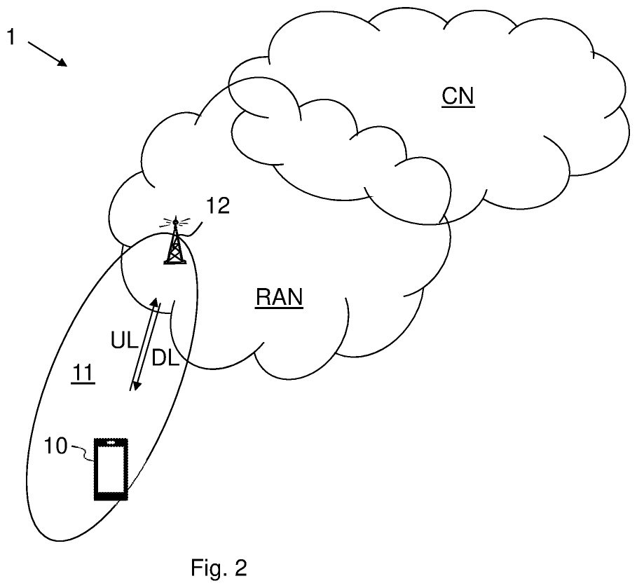

Embodiments herein relate to wireless communications networks in general. FIG. 2 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a user equipment (UE) 10, exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the UE in form of DL transmissions to the UE and UL transmissions from the UE. It should be noted that a service area may be denoted as cell, beam, beam group or similar to define an area of radio coverage.

In the embodiments described herein the radio network node 12 broadcasts System Information (SI) in the first service area 11. The SI comprises an association parameter associating a GID with a network in the SI. The proposed solution is independent of any GID encoding.

The format of broadcasting the association parameter, or GID info, may be performed in different ways. In one embodiment, the association parameter takes the form of a bitmap where each bit points to one of the networks broadcasted in SIB1, e.g., in a plmn-IdentityInfoList if the GID is associated with a PLMN, or in a npn-IdentityInfoList if the GID is associated with an NPN. In another embodiment, the association parameter takes the form of list of indexes, where each index points to one of the networks broadcasted in SIB1.

The broadcast information may further comprise an indication of the form of the association parameter being used, i.e., whether this is a bitmap or a list of indexes.

Embodiments herein also cover transmission of the human readable group name (HRGN) associated with the GID. The list of GIDs may be broadcast together with a list of HRGNs for the GIDs in the same SIB. Alternatively, the HRGN may be broadcast separately from the GID, and may be included in the same SIB that includes the HRNNs for the NPNs, i.e., SIB10, or may be broadcast independently in a new SIB.

In another embodiment, the list of GIDs and the HRGNs are broadcast in separate SIBs and an association is made between the GIDs and HRGNs. The SIB including the HRGNs may either be the same SIB that includes the HRNNs for the NPNs, i.e., SIB10, or it may be a new SIB.

It is herein provided a solution by which association between a GID and a network ID may be made efficiently and for many different networks in the same broadcast.

In addition, embodiments herein also allow the GID to be associated with a HRGN in an efficient manner.

By introducing a new information element that includes all GIDs and their association to the existing networks, a minimal number of bits would be consumed in the broadcast. Moreover, the GIDs would only need to be broadcasted once even if they are associated with multiple networks.

The above is further enhanced by providing information on how the new information element is structured, which in turn allows for greater flexibility on optimizing the signaling overhead. Since the size of the list may be variable depending on the number of networks it supports in the RAN sharing scenario, the most optimal format can be selected without affecting the UE's ability to interpret the information provided.

Another advantage is that all GIDs may be put in a separate SIB, thus avoiding the use of constrained bits available in SIB1 given the limits on the SIB size. This is of particular interest for scenarios in which a high number GIDs are supported by a network. Also, this separate SIB potentially does not have to be repeated with the same frequency as SIB1 since SIB1 contains mainly essential access information for the UE.

Another advantage is that it allows for an efficient association between a GID and a HRGN.

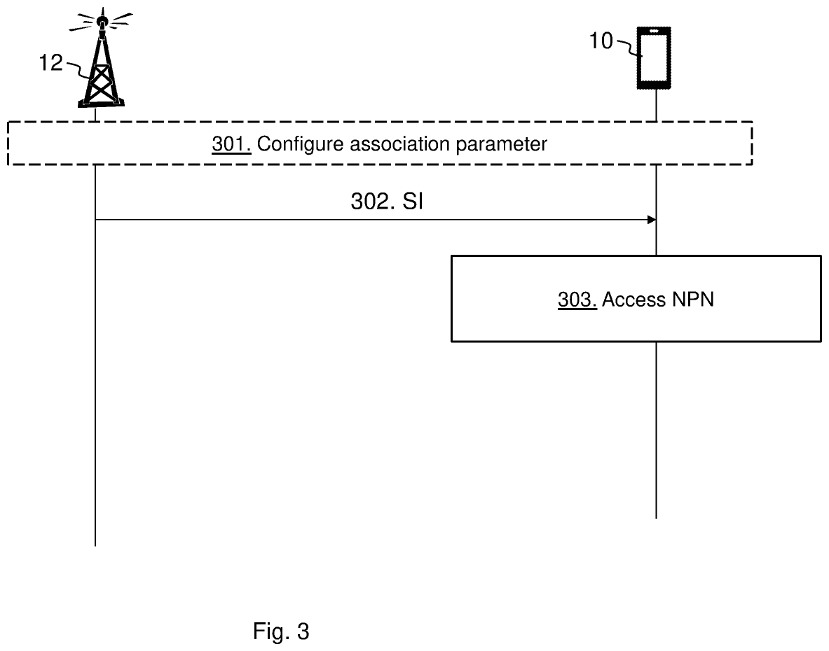

FIG. 3 is a combined signalling and flowchart scheme according to embodiments herein.

Action 301. The radio network node 12 may configure the UE 10 with GID and/or one or more association parameters such as lists and/or bitmaps. The configuration may be preconfigured at the UE 10 or performed by another radio network node.

Action 302. The radio network node 12 transmits or broadcasts the SI, wherein the SI comprises the association parameter associating the GID with the one or more networks in the system information. The association parameter may be a bit value in a bitmap and/or an index in a list of networks.

Action 303. The UE 10 receives the SI and uses the association parameter to retrieve access information for accessing a network associated with the GID of the UE 10, i.e., using the association parameter.

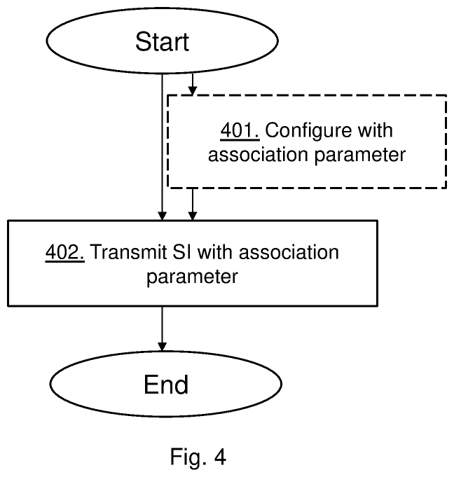

The method actions performed by the radio network node 12 for handling communication in the wireless communications network according to embodiments will now be described with reference to a flowchart depicted in FIG. 4. The actions do not have to be taken in the order stated below but may be taken in any suitable order. Dashed boxes indicate optional features.

Action 401. The radio network node 12 may configure the UE 10 with GIDs and/or association parameters.

Action 402. The radio network node 12 transmits or broadcasts the SI with the association parameter associating the GID with one or more networks such as NPNs or PLMNs. The association parameter may comprise a bitmap. The one or more networks may comprise a SNPN, and the association parameter may indicate that the SNPN supports several different GIDs. The bitmap may comprise bits where each bit points to one of the networks broadcasted in the SI such as SIB1. For example, the bitmap may point to a network e.g. in a plmn-IdentityInfoList if the GID is associated with a PLMN, or in a npn-IdentityInfoList if the GID is associated with an NPN. The association parameter may comprise an index in a list of indexes, where each index points to one of the networks broadcasted in the SI. The radio network node 12 may further broadcast an indication of type of the association parameter being used, i.e., whether this is a bitmap or a list of indexes.

The radio network node 12 may additionally or alternatively broadcast a list of GIDs together with a list of HRGNs for the GIDs in the same SIB. Alternatively, the HRGN may be broadcast separately from the GID, and may be included in the same SIB that includes the HRNNs for the NPNs, e.g., in SIB10, or may be broadcast independently in a new SIB. In a similar manner, the radio network node 12 may broadcast the list of GIDs and the HRGNs in separate SIBs and an association may be made between the GIDs and HRGNs. The SIB including the HRGNs may either be the same SIB that includes the HRNNs for the NPNs, e.g., SIB10, or may be a new SIB.

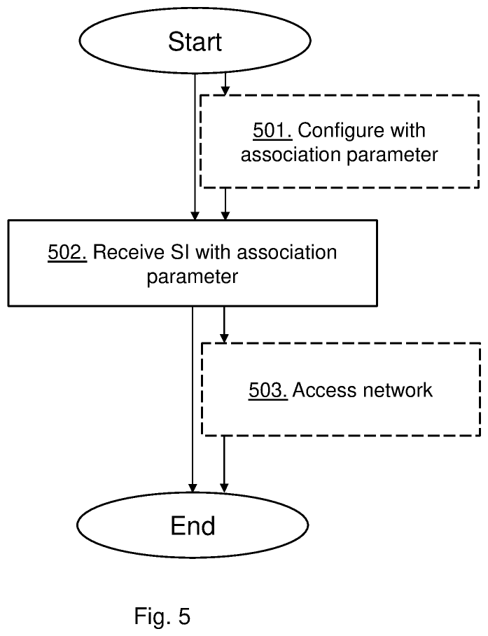

The method actions performed by the UE 10 for handling communication in the wireless communications network according to embodiments will now be described with reference to a flowchart depicted in FIG. 5. The actions do not have to be taken in the order stated below, but may be taken in any suitable order. Dashed boxes indicate optional features.

Action 501. The UE 10 may be configured (preconfigured or from the radio network node 12) with GIDs and/or association parameters.

Action 502. The UE 10 receives the SI with the association parameter associating the GID with the one or more networks such as NPNs or PLMNs. The association parameter may comprise the bitmap. The one or more networks may comprise a SNPN, and the association parameter may indicate that the SNPN supports several different GIDs. The bitmap may comprise bits where each bit points to one of the networks broadcast in the SI such as SIB1. For example, the bitmap may point to a network e.g. in a plmn-IdentityInfoList if the GID is associated with a PLMN, or in a npn-IdentityInfoList if the GID is associated with an NPN. The association parameter may comprise the index in the list of indexes, where each index points to one of the networks broadcasted in the SI. The UE 10 may further receive the indication of type of the association parameter being used, i.e., whether the association parameter is a bitmap or a list of indexes.

The UE 10 may additionally or alternatively receive the list of GIDs together with the list of HRGNs for the GIDs in the same SIB. Alternatively, the HRGN may be received separately from the GID, and may be included in the same SIB that includes the HRNNs for the NPNs, e.g., in SIB10, or may be received independently in a new SIB. The UE 10 may receive the list of GIDs and the HRGNs in separate SIBs and an association may be made between the GIDs and HRGNs. The SIB including the HRGNs may either be the same SIB that includes the HRNNs for the NPNs, e.g., SIB10, or may be a new SIB. Action 503. The UE 10 may then use the association parameter to access a network. For example, the UE 10 may select one of the networks it is allowed to access, based on the GID(s) the UE 10 is configured with. For example, the UE 10 may select the network which corresponds to the associated network ID based on the association parameter. HRGN may be used by the UE 10 in manual selection. According to this mode of operation, the UE 10 may retrieve the available HRGNs from the SIB, may render to the user, who manually may select one of them. Then the UE 10 may select the GID associated to this HRGN. Finally, the UE 10 may select a network which supports the selected GID.

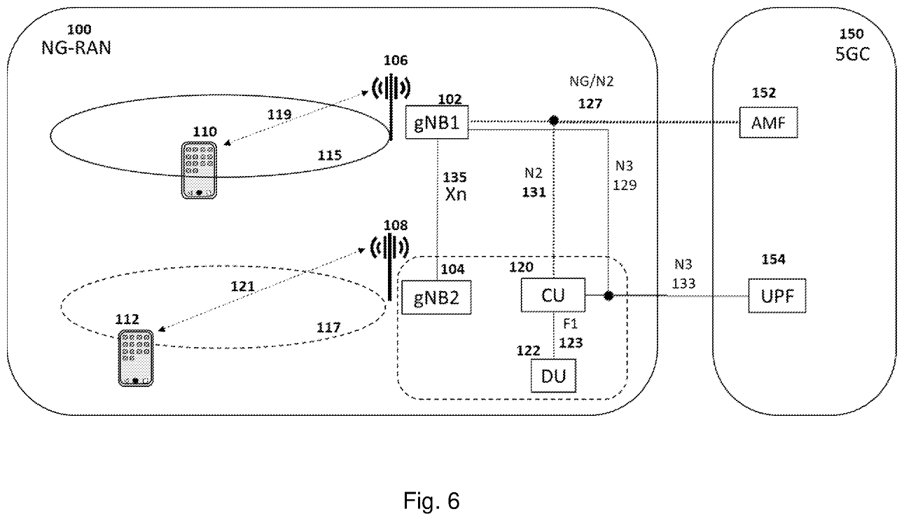

FIG. 6 shows an exemplary 5G communication system comprising fifth generation core (5GC) and NG-RAN.

FIG. 6 illustrates an exemplary communication system pursuant to 3GPP specifications for 5GC) 150 and 5G Radio Access Network or NG-RAN 100 as described in, e.g., 3GPP TS 23.501 [3], TS 38.300 [4] and TS 38.401 [5].

The 5G-RAN or NG-RAN consists of gNBs 102, 104 that connects to antenna elements 106, 108 via which wireless communication 119, 121 is possible to/from UEs 110, 112 within a certain coverage area 115, 117. The interface between the gNB 102, 104 and the UE 110, 112 is sometimes referred to as the Uu interface. Different gNBs can connect to each other via a direct interface referred to as Xn 135 interface. This interface is typically used for mobility between different gNBs, e.g., when UEs move between different coverage areas served by different gNBs. In FIG. 6 gNB2 104 is illustrated with additional details in how it may be built-up. A gNB may consist of a Central Unit (CU) 120 and at least one Distributed Unit (DU) 122. The CU 120 can connect with the DU 122 via an F1 interface 123. The gNBs 102, 104 are then connected to two different nodes in the 5G Core network, one for the user plane traffic and one for control plane traffic. The interface for control plane NG/N2 127, 131 towards an Access and Mobility management Function (AMF), 152 and the interface for user plane traffic N3, 129, 133 for communication towards a User Plane Function (UPF) 154. The standard describes, e.g., N5, N7, etc., to be the reference point between two nodes/end points, synonymous to interface as it is sometimes done also in specifications. The connection to the core network goes in the illustration via the CU in the gNB, as exemplified by gNB2 104 and CU 120. It is the role of the gNB to terminate the control signaling that establishes and controls the air interface connection towards the UE. It is further the role to be the communication point towards the radio access network 100 for the core network 150. While the interfaces have been denoted with, e.g., N5, N7 etc. in the figure (N+number) this is usually referring to a reference point between the different nodes, in this description the same denotations will be used to denote the interfaces between the entities in its entirety.

Broadcast of the GID and associated parameters will now be described. From gNBs 106, 108 information is broadcast in SIBs. A specific SIB may be introduced to broadcast a GID or a list of GIDs. The GID may be part of a list, e.g., a list of gid-InfoList, that may be defined as a list of elements containing: A GID, and/or a network association, i.e. the association parameter, for the GID. The network association would in these cases be an indication of what networks from the network list (the npn-IdentityInfoList and/or the plmn-IdentityList) support access for a certain GID.

In embodiments addressing KI #1 from TR 23.700-07 [1], a GID would be associated to one or more SNPNs only. However, in more generic scenarios, the GID may be associated with any network type, including e.g., PLMNs or PNI-NPNs, where the latter may be defined by CAG cells.

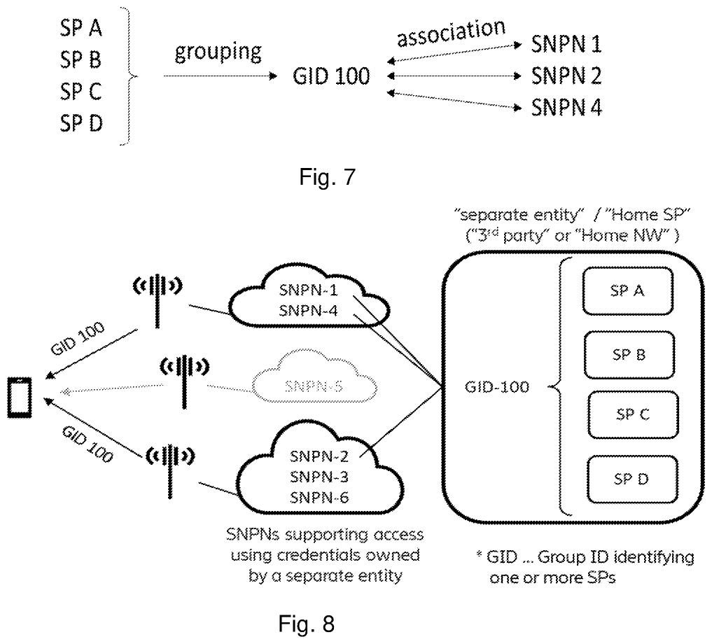

In the example in FIG. 7 SNPNs are referred to since this is being used in TR 23.700-07, to explain how the GID which has been introduced in the TR, is supposed to be used. The GID groups SPs and association parameter connect GID with one or more networks, e.g., SNPNs 1,2 and 4.

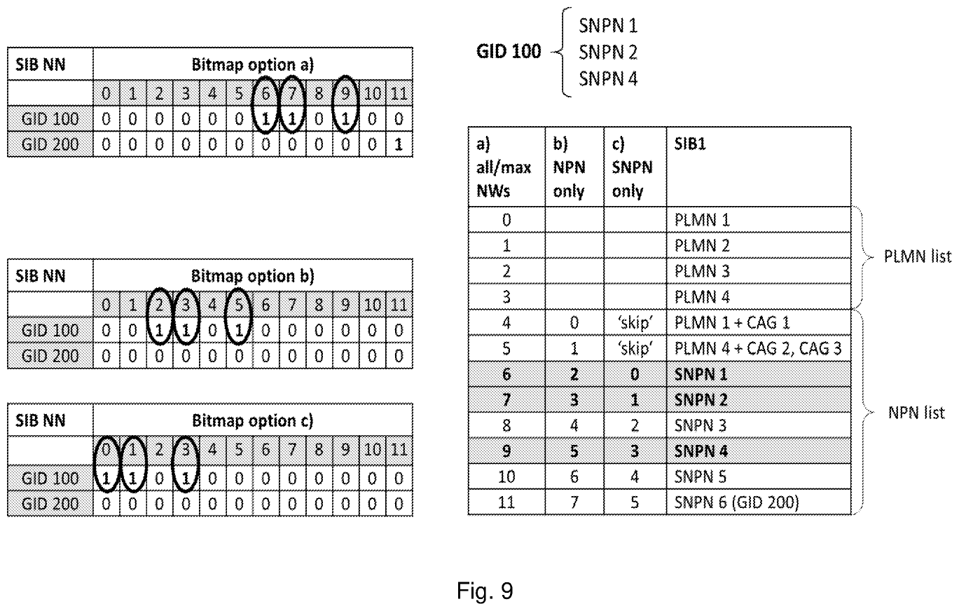

FIG. 8 shows a UE network selection behavior based on GID broadcast, e.g., from SNPN-1. SPs A-D belong to an SP group identified by GID 100. SPs A-D are service providers. UEs that have a subscription from at least one of the service providers can access any network, note that in FIG. 8, only SNPNs are illustrated, that broadcasts a certain GID, in this case GID 100.

UEs that have credentials from any of the SPs, SP A to SP D, may be configured with GID 100 and may then, when seeking an SNPN to access, look for a broadcast of this GID. This means that, e.g., for SNPN 1 that supports access using credentials from any SP A-SP D, the network only has to broadcast “GID 100”. UEs would then be able to identify and ultimately select an SNPN for access, based on this GID association. If, in a later stage, e.g., SP A negotiates access also in SNPN 5 for its users, there is no need to update any UEs for purposes of allowing them to access also this SNPN, since it would be straightforward to also start to broadcast GID 100 in cells for accessing SNPN 5.

In the illustrations in FIG. 7 and FIG. 8, only one GID is illustrated, but an SNPN may of course support access using credentials from many different SPs and these SPs may be associated to many different GIDs, meaning that the SNPN may have to indicate to UEs that it supports several different GIDs.

There are multiple options how the association parameters can be broadcast. A straightforward approach would be to introduce a new information element (IE) that comprises a list of supported GIDs per SNPN as described in 3GPP TR 23.700-07 [1].

In other words, as for the example shown in FIG. 8, SNPNs 1 and 4 are part of a shared network, and both are associated with GID 100, the SIB would contain the following information for these SNPNs:
SNPN 1 would include GID 100 in its GID list
SNPN 4 would also include GID 100 in its GID list.

Thus, the drawback of this kind of signaling is that GID would be broadcast twice.

A new information element according to embodiments herein may therefore comprise one or several GIDs and for each GID, associate it with one or several networks using the association parameter.

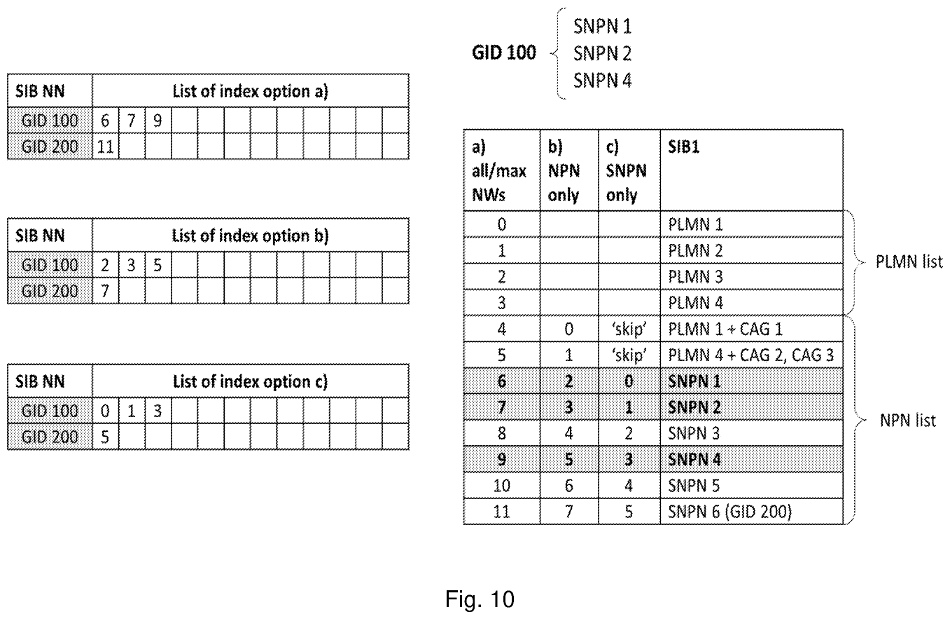

FIG. 9 illustrates multiple ways of such association parameter. The bitmap values indicate that the GID 100 is supported by networks according to corresponding indices in a list of networks. Thus, FIG. 9 shows a GID and associated networks using a bitmap to point to the networks.

In this example, there are two GIDs. In association to each GID is a bitmap. In the illustration, there is also a view of what is broadcast in SIB1 and the corresponding positions within the network lists, illustrating the following bitmap options:
a) a combined list of PLMNs, included in the plmn-IdentityList, and a number of CAGs and SNPNs (included in the npn-IdentityInfoList). The indexing for the networks in the plmn-identityList, also referred to as PLMN-list, and the npn-IdentityInfoList, also referred to as NPN-list, is a joint index, spanning both lists.
b) a list of NPNs only, i.e. CAGs and NPNs provided in npn-IdentityInfoList, where only the elements in the NPN list are indexed.
c) a list of SNPNs only where only the SNPNs within the npn-IdentityInfoList are indexed.

Another option would be to have two separate bitmaps, one to point to the PLMN list and one to the NPN list. However, that option would create more broadcasting overhead, and the number of the combined networks is in any case limited to 12 (this option is not illustrated in FIG. 5).

Below shows an ASN.1 encoding example introducing a new GID-InfoList in a new SIB, SIBXY, which will get an appropriate SIB number when included in TS 38.331 [2]. The GID-InfoList consists of one or more GID-Info elements, each of them containing the GID as well as the associated SNPNs. As described in the background, the GID reuses the same encoding as the SNPN ID.

GID definition in accordance with TR 23.700-07 [1]:

| | |
|---|---|
| GID ::= | SEQUENCE { |
| plmn-Identity | PLMN-Identity, |
| nid-List-r16 | SEQUENCE (SIZE (1..maxNPN-r16)) OF NID-r16 |

}

In the ASN.1 coding example below, the association between a GID, e.g., GID 100 is done by setting bits in a bitmap, spanning the length of the maximum number of networks in SIB1 (which is at most 12). In that example, it is illustrated that a UE configured with GID 100 may access either SNPN 1, 2, or 4, whereas for GID 200, it can only access SNPN 6 (see bitmap option a).

Both the GID and the bitmap indication may be broadcast in a separate SIB to allow for flexible configuration of the schedule.

The simplest approach to address only SNPNs would be to index all list elements within the NPN-list (b). For example, the SNPN 1 may correspond to index 2 if all elements from the NPN-list are counted, and SNPN 1 would correspond to index 0 if the indexing is only for SNPNs within the NPN-list (c).

### Sibxy Information Element

```
  -- ASN1START
  -- TAG-SIBXY-START
```

| SIBXY-r17 ::= | SEQUENCE { | |
|---|---|---|
| gid-InfoList-r17 | GID-InfoList-r17 | OPTIONAL, -- Need R |

```
    ...
  }
```

| | |
|---|---|
| GID-InfoList-r17 ::= | SEQUENCE (SIZE (1..maxGID-r17)) OF GID-Info-r17 |

```
  -- TAG-SIBXY-STOP
  -- ASN1STOP
  ASN.1 example where the GID-InfoList is provided in a new SIB, SIBXY.
  Option a) GID-Info information element using maximum number of NPNs (12)
  -- option a)
```

| | |
|---|---|
| GID-Info-r17 ::= | SEQUENCE { |

| | |
|---|---|
| gid | GID, |
| associatedSNPNs | BIT STRING (SIZE (maxNPN-r16)) |

```
OPTIONAL -- Need R
    ...
  }
```

SIBXY field descriptions

gid
The Group ID which identifies a group of separate entities, each may own a UE's
credentials/subscriptions.
associatedSNPNs
The n-th bit of the bitmap corresponds to the n-th NPN of SIB1, i.e. the n-th NPN
listed in npn-IdentityInfoList. A bit set to ‘1’ means that the corresponding NPN supports
access using credentials from a “separate entity” which is identified by this GID. If the
number of NPNs in SIB1 equals N, only the first N bits of the bitmap would be valid, and
the remaining bits can be ignored.

Option b) GID-Info information element using number of SNPNs as actually broadcast in SIB1

-- option b)

| GID-Info-r17 ::= | SEQUENCE { | |
|---|---|---|
| | gid | GID, |
| | associatedSNPNs | BIT STRING (SIZE (1..maxNPN- |

| | |
|---|---|
| r16)) | OPTIONAL, -- Need R |
| | ... |

}

associatedSNPNs
The same amount of SNPN elements as the number of SNPNs in SIB 1 are
included. The n-th bit of the bitmap corresponds to the n-th SNPN of SIB1, i.e. the n-th
SNPN listed in npn-IdentityInfoList. If PNI-NPNs are included in the npn-IdentityInfoList, the
PNI-NPNs are not counted for the numbering.
A bit set to ‘1’ means that the corresponding SNPN supports access using
credentials from a “separate entity” which is identified by this GID.
If absent, the GID is associated to all SNPNs.

Alternatively, associated SNPNs may be OPTIONAL, —Need S. E.g. this may be included in the ASN.1.

In another example, the association between the GID and the network may not be performed using a bitmap, but rather communicated using/via a list of indexes, such that for each GID, there is a list of association indexes, where the index may be either
a) the same as calculated when the UE 10 would send a message to the network indicating which network has been selected using the combined list of PLMNs and NPNs; or
b) calculated spanning only over the NPNs, e.g. the full NPN-IdentityInfoList, it uses the same indexing approach as for HRNN association with an NPN or
c) only over the SNPNs within the NPN-IdentityInfoList, where PNI-NPNs entries would be skipped for the indexing.

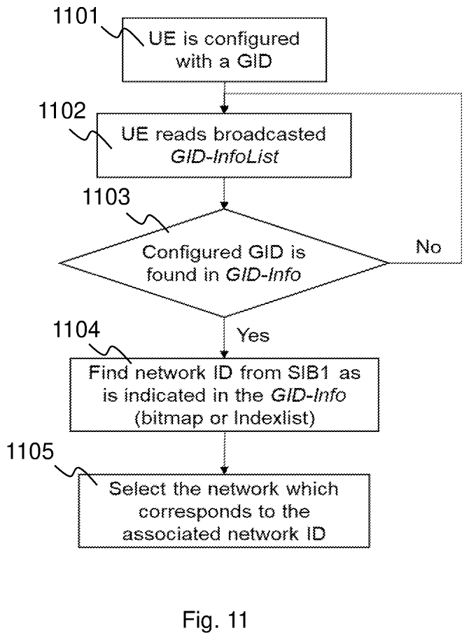

In FIG. 10 it is illustrated an example wherein GIDs and associated networks uses indexes, i.e., the association parameter, to point to the networks.

In the example shown in FIG. 10, the index list replaces the bitmap: GID 100 is associated to SNPN 1, 2, and 4, and thus, indexes 6, 7 and 9 would be broadcast for option a), whereas GID 200 is associated to SNPN 6 only, so that only index 11 would be broadcast together with GID 200.

The corresponding ASN.1 examples are shown below. For better readability, some of the r17 tags are omitted which Indicate in which Release a field or information elements has been added.

### GID-Info Information Element

| | |
|---|---|
| GID-Info-r17 ::= | SEQUENCE { |
| gid | GID |

OPTIONAL, -- Need R

| | |
|---|---|
| associatedSNPNs | SEQUENCE (SIZE (1..maxNPN-r16)) |
| OF SNPN-Index-r17 | OPTIONAL, -- Need R |

```
    ...
  }
```

| | |
|---|---|
| SNPN-Index-r17 | = INTEGER (1..maxNPN-r16) |
| GID-Info-r17 ::= | SEQUENCE { |
| gid | GID |

OPTIONAL, -- Need R

| | |
|---|---|
| associatedNetworks | SEQUENCE (SIZE (1..maxNetworks- |
| r17)) OF Network-Index-r17 | OPTIONAL, -- Need R |

```
    ...
  }
```

| | |
|---|---|
| Network-Index-r17 | ::= INTEGER (1..maxNetworks-r17) |
| maxNetworks-r17 | INTEGER ::= 12 -- Maximum number of |

networks (PLMN+NPNs) broadcast and reported by UE at establishment

### Asn. 1 Example for Index Approach for SNPNs Only

### Asn. 1 Example for Index Approach for any Type of Network

Another signaling optimization may in some embodiments be to allow the network to choose between the bitmap and indexing option to associate the SNPNs with the GID using, e.g., a CHOICE structure as illustrated in the ASN.1 example below. Thus, the network may include an indication of type of the association parameter being used.

| GID-Info-r17 ::= | SEQUENCE { |
|---|---|
| gid | GID |
| OPTIONAL, -- Need R | |
| associatedNetworks | CHOICE { |
| index | SEQUENCE (SIZE |
| (1..maxNPN-r16)) OF SNPN-Index-r17, | |
| bitmap | BIT STRING (SIZE |

```
(1..maxNetworks-r17))
    } OPTIONAL, -- Need R
    ...
  }
```

Above and/or below ASN.1 example indicates the structure of the new GID-Info information element.

Manual selection using a human readable name for the GID, e.g., HRGN, will now be described. In connection to NPNs, the 5G standard allows for an association between the network and a HRNN for purposes of manual network selection. In an example scenario comprising a manual network selection mode, the UE 10 typically displays to the user of the UE the names of the networks that are available for selection, and sometimes also names of the networks that are detected, but not available for selection, and for NPNs, the network may be configured with a name to associate with, e.g., a CAG cell or an SNPN ID may be associated with a certain network name. The association parameter such as the GID-Info, which contains/comprises all parameters that are associated with the GID, may comprise the HRGN as illustrated below.

### Gid-Info Information Element

| | |
|---|---|
| GID-Info-r17 ::= | SEQUENCE { |
| gid | GID |

OPTIONAL, -- Need R

| | |
|---|---|
| hrgn | OCTET STRING (SIZE (1.. maxHRGN-Len-r17)) |

OPTIONAL, -- Need R

| | |
|---|---|
| associatedNetworks | SEQUENCE (SIZE (1..maxNetworks-r17)) |
| OF Network-Index-r17 | OPTIONAL, -- Need R |

```
    ...
  }
```

| | |
|---|---|
| Network-Index-r17 | = INTEGER (1.. maxNetworks-r17) |

The ASN.1 example showing above GID-Info being extended with the HRGN list.

The SIB10 may be extended with a HRGN for GIDs, that can be associated with GIDs from the GID list in much the same way as the HRNNs for SNPNs and CAG cells are above. The HRGNs may be introduced as separate elements in SIB10, e.g., as HRGN-List-r17 with HRGN-r17 elements, see example illustrated below. If the HRGNs have the same format as the HRNN it may also be possible to re-use the existing HRNN-r16 element rather than introducing a new HRGN-r17 element.

### SIB10 Information Element

```
  -- ASN1START
  -- TAG-SIB10-START
```

| SIB10-r16 ::= | SEQUENCE { | |
|---|---|---|
| hrnn-List-r16 | HRNN-List-r16 | OPTIONAL, -- |

Need R

| | | |
|---|---|---|
| lateNonCriticalExtension | OCTET STRING | OPTIONAL, |

```
    ...,
    [[
```

| | | |
|---|---|---|
| hrgn-List-r17 | HRGN-List-r17 | OPTIONAL, -- |

```
Need R
    ]]
  }
```

| | |
|---|---|
| HRNN-List-r16 ::= | SEQUENCE (SIZE (1..maxNPN-r16)) OF HRNN-r16 |
| HRNN-r16 ::= | SEQUENCE { |
| hrnn-r16 | OCTET STRING (SIZE(1.. maxHRNN-Len-r16)) |

OPTIONAL -- Need R
}

| | |
|---|---|
| HRGN-List-r17 ::= | SEQUENCE (SIZE (1..maxGID-r17)) OF HRGN-r17 |

}

| | |
|---|---|
| HRGN-r17 ::= | SEQUENCE { |
| hrgn-r17 | OCTET STRING (SIZE (1..maxHRGN-Len-r17)) |

```
OPTIONAL -- Need R
  }
  -- TAG-SIB10-STOP
  -- ASN1STOP
```

SIB10 field descriptions

HRNN-List
The same amount of HRNN elements as the number of NPNs in SIB 1 are
included. The n-th entry of HRNN-List contains the human readable network name of the
n-th NPN of SIB1. The hrnn in the corresponding entry in HRNN-List is absent if there is no
HRNN associated with the given NPN.
HRGN-List
The same amount of HRGN elements as the number of GIDs in SIBXY are
included. The n-th entry of HRGN-List contains the human readable group name of the n-
th GID of SIBXY. The hrgn in the corresponding entry in HRGN-List is absent if there is no
HRGN associated with the given GID.

The ASN.1 example showing SIB10 being extended with the HRGN list.

The HRGNs may be specified in a separate SIB, i.e., separate from SIB10, to allow for, e.g., different SIB repetition patterns.

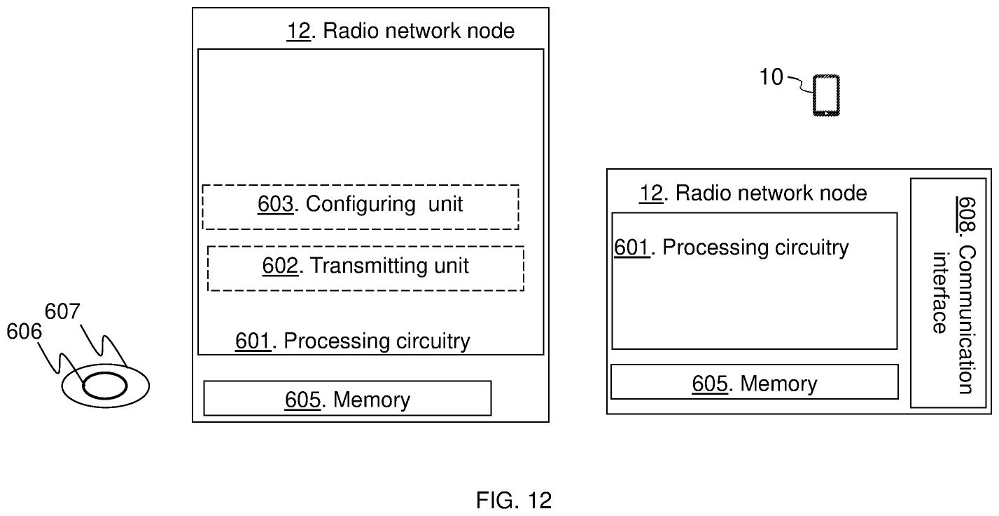

UE behavior using the new GID info, being an example of the association parameter(s), is exemplified in FIG. 11.

The UE 10 may be configured with a GID and performing network selection, see action 1101, the UE 10 may scan and detect available networks. The UE 10 may then detect, e.g., read, broadcasts of network IDs and broadcasts of GID information, see action 1102.

The networks available in a cell may be derived from the plmn-IdentityList and the npn-IdentityInfoList and how these networks are potentially associated with the GID are provided in the association parameter, e.g., a new gid-InfoList.

Now, the UE 10 may, by comparing the GIDs it is configured with, with the broadcasted GIDs contained in the gid-InfoList, also detect which networks are available for selection, action 1103. If the UE 10 finds the GID in a GID-Info entry, the UE 10 may reveal the association between the networks, e.g., SNPNs, and this GID. For example, in action 1104, the UE 10 finds network ID from SIB1 as is indicated in the GID-info.

The network selection procedure at the UE 10 would then select one of the networks it is allowed to access, based on the GID(s) the UE 10 is configured with. For example, the UE 10 may select the network which corresponds to the associated network ID, action 1105.

This modified network selection procedure is illustrated in FIG. 11.

In one specific case, the UE 10 may be equipped with credentials from a SP, and these credentials may be used to access certain SNPNs, i.e., SNPNs supporting authentication by this SP. Additionally, the UE 10 may be configured with a GID that comprises identification of this SP.

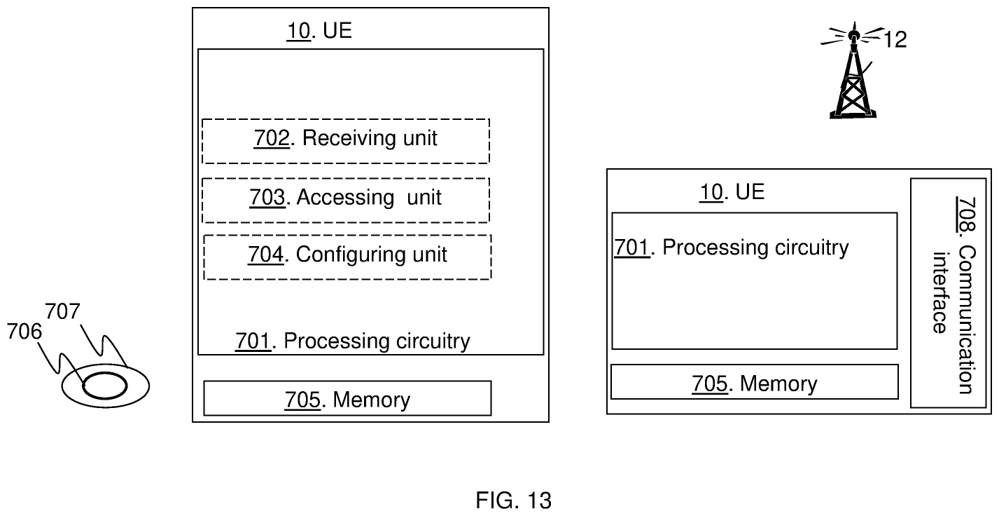

FIG. 12 is a block diagram depicting the radio network node 12 for handling communication in the wireless communications network 1 according to embodiments herein.

The radio network node 12 may comprise processing circuitry 601, e.g., one or more processors, configured to perform the methods herein.

The radio network node 12 may comprise a transmitting unit 602, e.g. a transmitter or a transceiver. The radio network node 12, the processing circuitry 601 and/or the transmitting unit 602 is configured to transmit or broadcast the SI to one or more UEs. The SI comprises the association parameter associating the GID with the one or more networks such as NPNs or PLMNs. The association parameter may comprise the bitmap. The one or more networks may comprise a SNPN, and the association parameter may indicate that the SNPN supports several different GIDs. The bitmap may comprise bits where each bit points to one of the networks broadcasted in the SI such as SIB1. For example, the bitmap may point to a network e.g. in a plmn-IdentityInfoList if the GID is associated with a PLMN, or in a npn-IdentityInfoList if the GID is associated with an NPN. The association parameter may comprise the index in the list of indexes, where each index points to one of the networks broadcasted in the SI. The radio network node 12, the processing circuitry 601 and/or the transmitting unit 602 may further be configured to transmit or broadcast the indication of type of the association parameter being used, i.e., whether this association parameter is a bitmap or a list of indexes.

The radio network node 12, the processing circuitry 601 and/or the transmitting unit 602 may further be configured to broadcast the list of GIDs together with the list of HRGNs for the GIDs in the same SIB. Alternatively, the HRGN may be broadcast separately from the GID, and may be included in the same SIB that includes the HRNNs for the NPNs, e.g., in SIB10, or it may be broadcast independently in a new SIB. The radio network node 12, the processing circuitry 601 and/or the transmitting unit 602 may further be configured to transmit or broadcast the list of GIDs and the HRGNs in separate SIBs and an association may be made between the GIDs and HRGNs. The SIB including the HRGNs may either be the same SIB that includes the HRNNs for the NPNs, e.g., SIB10, or may be a new SIB.

The radio network node 12 may comprise a configuring unit 603. The radio network node 12, the processing circuitry 601 and/or the configuring unit 603 may be configured to configure the UE 10 with the association parameter and/or GID.

The radio network node 12 may comprise a memory 605. The memory 605 comprises one or more units to be used to store data on, such as data packets, association parameter, GIDs, networks, HRGNs, HRNNs, mobility events, measurements, sizes related to types of data transmissions, events and applications to perform the methods disclosed herein when being executed, and similar. Furthermore, the radio network node 12 may comprise a communication interface 608 such as comprising a transmitter, a receiver, a transceiver and/or one or more antennas.

The methods according to the embodiments described herein for the radio network node 12 are respectively implemented by means of e.g. a computer program product 606 or a computer program, comprising instructions, i.e., software code portions, which, when executed on at least one processor, cause the at least one processor to carry out the actions described herein, as performed by the radio network node 12. The computer program product 606 may be stored on a computer-readable storage medium 607, e.g. a disc, a universal serial bus (USB) stick or similar. The computer-readable storage medium 607, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node 12 for handling communication in a wireless communications network, wherein the radio network node 12 comprises processing circuitry and a memory, said memory comprising instructions executable by said processing circuitry whereby said radio network node 12 is operative to perform any of the methods herein.

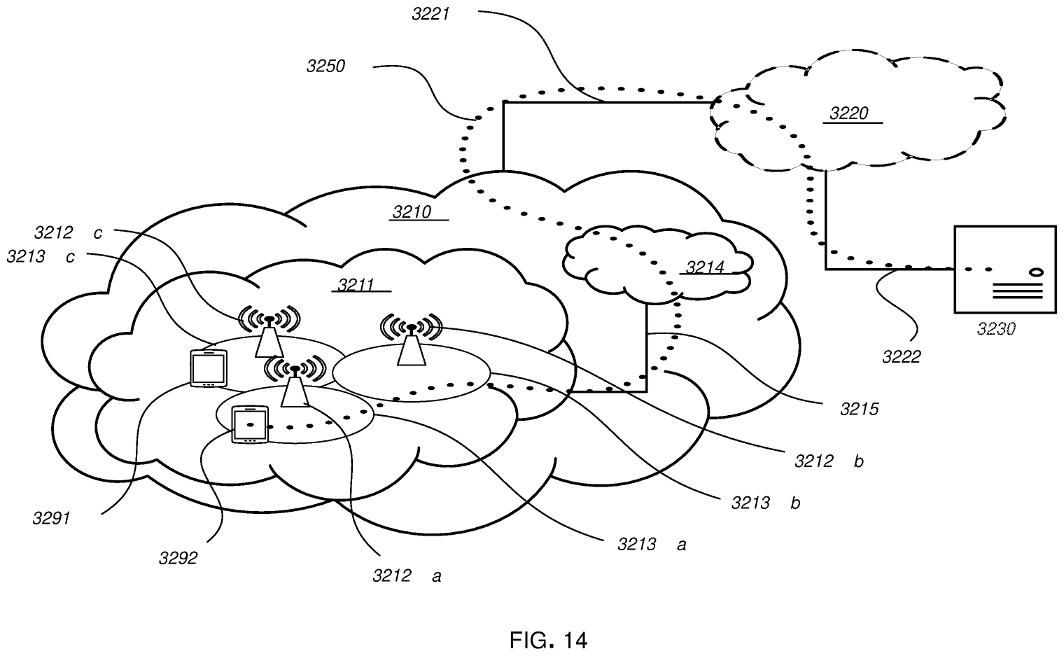

FIG. 13 is a block diagram depicting the UE 10 for handling communication in the wireless communications network 1 according to embodiments herein.

The UE 10 may comprise processing circuitry 701, e.g., one or more processors, configured to perform the methods herein.

The UE 10 may comprise a receiving unit 702, e.g., a reader, a receiver or a transceiver. The UE 10, the processing circuitry 701 and/or the receiving unit 702 is configured to receive the SI from the radio network node 12. The SI comprises the association parameter associating the GID with the one or more networks such as NPNs or PLMNs. The association parameter may comprise the bitmap. The one or more networks may comprise a SNPN, and the association parameter may indicate that the SNPN supports several different GIDs. The bitmap may comprise bits where each bit points to one of the networks broadcasted in the SI such as SIB1. For example, the bitmap may point to a network e.g. in a plmn-IdentityInfoList if the GID is associated with a PLMN, or in a npn-IdentityInfoList if the GID is associated with an NPN. The association parameter may comprise the index in the list of indexes, where each index points to one of the networks broadcasted in the SI. The UE 10, the processing circuitry 701 and/or the receiving unit 702 may be configured to receive the indication of type of the association parameter being used, i.e., whether this is a bitmap or a list of indexes.

The UE 10, the processing circuitry 701 and/or the receiving unit 702 may be configured to receive the list of GIDs together with the list of HRGNs for the GIDs in the same SIB. Alternatively, the HRGN may be received separately from the GID, and it may be included in the same SIB that includes the HRNNs for the NPNs, e.g. in SIB10, or it may be received independently in a new SIB. The UE 10, the processing circuitry 701 and/or the receiving unit 702 may be configured to receive the list of GIDs and the HRGNs in separate SIBs and an association may be made between the GIDs and HRGNs. The SIB including the HRGNs may either be the same SIB that includes the HRNNs for the NPNs, e.g. in SIB10, or it may be a new SIB.

The UE 10 may comprise an accessing unit 703, e.g. a transmitter or a transceiver. The UE 10, the processing circuitry 701 and/or the accessing unit 703 may be configured to access the network based on the association parameter. E.g., the UE 10, the processing circuitry 701 and/or the accessing unit 703 may be configured to select a network to access corresponding to the network associated, from the association parameter, with the GID configured at the UE 10. The UE 10, the processing circuitry 701 and/or the accessing unit 703 may be configured to use the association parameter to access a network. For example, the UE 10, the processing circuitry 701 and/or the accessing unit 703 may be configured to select one of the networks it is allowed to access, based on the GID(s) the UE 10 is configured with.

The UE 10 may comprise a configuring unit 704. The UE 10, the processing circuitry 701 and/or the configuring unit 704 may be configured to receive configuration data to configure the association parameter at the UE 10 and/or the GID.

The UE 10 may comprise a memory 705. The memory 705 comprises one or more units to be used to store data on, such as data packets, grants, association parameter(s), indices, bitmap, indications, mobility events, measurements, events and applications to perform the methods disclosed herein when being executed, and similar. Furthermore, the UE 10 may comprise a communication interface 708 such as comprising a transmitter, a receiver, a transceiver and/or one or more antennas.

The methods according to the embodiments described herein for the UE 10 are respectively implemented by means of e.g. a computer program product 706 or a computer program, comprising instructions, i.e., software code portions, which, when executed on at least one processor, cause the at least one processor to carry out the actions described herein, as performed by the UE 10. The computer program product 706 may be stored on a computer-readable storage medium 707, e.g. a disc, a universal serial bus (USB) stick or similar. The computer-readable storage medium 707, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a wireless communications network, wherein the UE 10 comprises processing circuitry and a memory, said memory comprising instructions executable by said processing circuitry whereby said UE 10 is operative to perform any of the methods herein.

Embodiments herein may cover:

Embodiment 1. A method performed by a radio network node for handling communication in a wireless communications network, the method comprising:
transmitting SI with an association parameter associating a group identity, GID, with one or more networks in the SI.

Embodiment 2. The method according to embodiment 1, further comprising
configuring a UE with GIDs and/or association parameters.

Embodiment 3. The method according to any of the embodiments 1-2, wherein the association parameter comprises a bitmap where each bit points to one of the networks broadcasted in the SI such as SIB1, and/or comprises an index in a list of indexes, where each index points to one of the networks broadcasted in the SI.

Embodiment 4. The method according to any of the embodiments 1-3, further comprising broadcasting an indication of type of the association parameter being used.

Embodiment 5. The method according to any of the embodiments 1-4, further comprising broadcasting a list of GIDs together with a list of HRGNs for the GIDs in the same SIB or separately from the GID.

Embodiment 6. A method performed by a user equipment, UE, for handling communication in a wireless communications network, the method comprising:
receiving SI with an association parameter associating a group identity, GID, with one or more networks in the SI.

Embodiment 7. The method according to embodiments 6, further comprising
configuring the UE with one or more GIDs and/or one or more association parameters.

Embodiment 8. The method according to any of the embodiments 6-7, wherein the association parameter comprises a bitmap where each bit points to one of the networks broadcasted in the SI, and/or comprises an index in a list of indexes, where each index points to one of the networks broadcasted in the SI.

Embodiment 9. The method according to any of the embodiments 6-8, further comprising
using the association parameter to access a network.

Embodiment 10. The method according to embodiment 9, wherein using the association parameter comprises selecting one of the networks it is allowed to access, based on the GID(s) the UE is configured with.

Embodiment 11. The method according to any of the embodiments 6-10, further comprising receiving an indication of type of the association parameter being used.

Embodiment 12. The method according to any of the embodiments 6-11, further comprising broadcasting a list of GIDs together with a list of HRGNs for the GIDs in the same SIB or separately from the GID.

Embodiment 13. A radio network node for handling communication in a wireless communications network, wherein the radio network node is configured to:
transmit SI with an association parameter associating a group identity, GID, with one or more networks in the SI.

Embodiment 14. A user equipment, UE, for handling communication in a wireless communications network, wherein the UE is configured to
receive SI with an association parameter associating a group identity, GID, with one or more networks in the SI.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

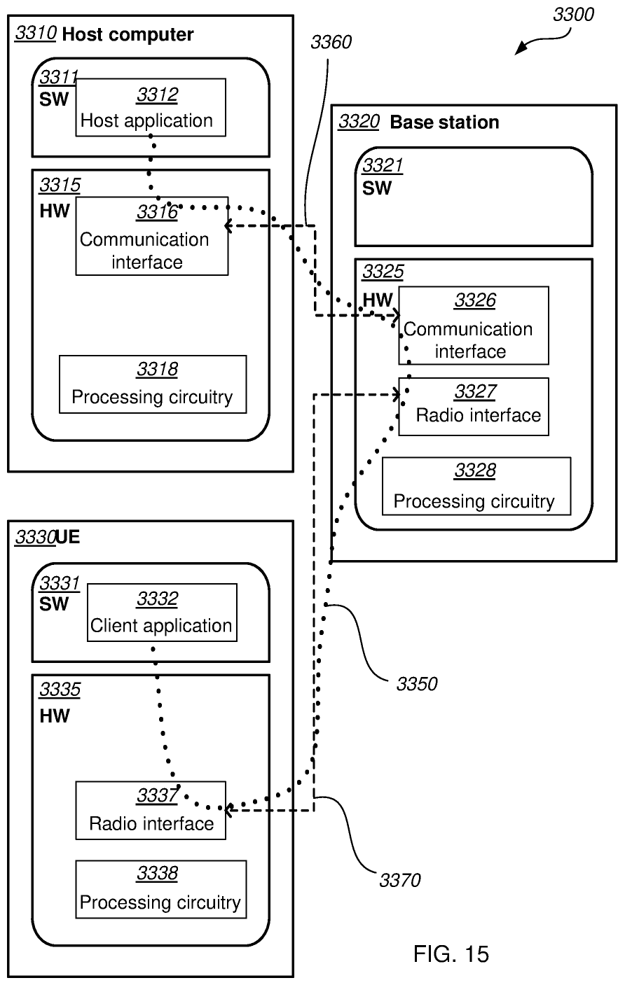

With reference to FIG. 14, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10 and relay UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 14 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

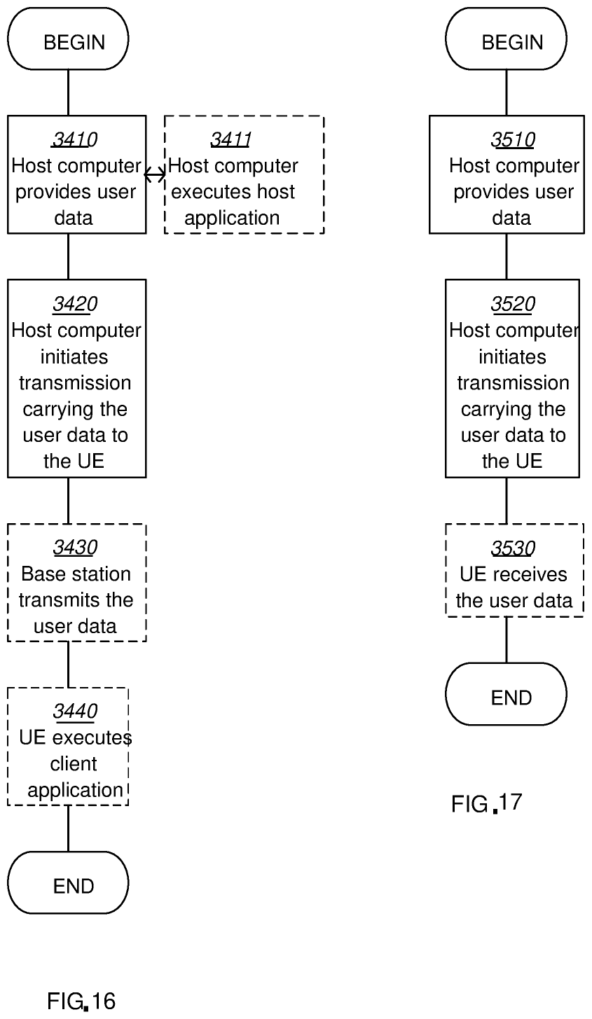

Example implementations, in accordance with an embodiment, of the UE, base station and host computer discussed in the preceding paragraphs will now be described with reference to FIG. 15. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 15) served by the base station 3320. The communication interface 3326 may be configured to facilitate a connection 3360 to the host computer 3310. The connection 3360 may be direct or it may pass through a core network (not shown in FIG. 15) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 15 may be identical to the host computer 3230, one of the base stations 3212a, 3212b, 3212c and one of the UEs 3291, 3292 of FIG. 14, respectively. This is to say, the inner workings of these entities may be as shown in FIG. 15 and independently, the surrounding network topology may be that of FIG. 14.

In FIG. 15, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since SI is transmitted more efficiently using less resources and thereby provide benefits such as reduced user waiting time, and better responsiveness since interference is reduced.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

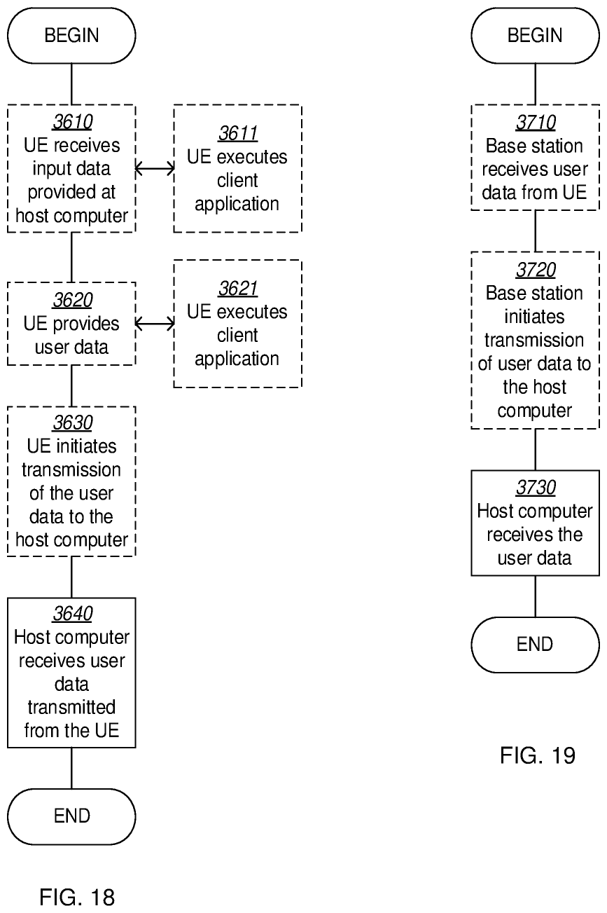

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| 5GC | 5th Generation Core Network |
| BSR | Buffer Status Report |
| CORESET | Control Resource Set |
| CN | Core Network |
| CSS | Common Search Space |
| DCI | Downlink Control Indicator |
| DVT | Data Volume Threshold |
| EDT | Early Data Transmission |
| MIB | Master Information Block |
| Msg | Message |
| NR | New Radio |
| PBCH | Physical Broadcast Channel |
| PDCCH | Physical Downlink Control Channel |
| PDSCH | Physical Downlink Shared Channel |
| PRACH | Physical Random Access Channel |
| RACH | Random Access Channel |
| RAR | Random Access Response |
| SDT | Small Data Transmission |
| SSB | Synchronization Signal Block |

### REFERENCES

1. 3GPP TR 23.700-07 v1.2.0: Study on enhanced support of non-public networks
2. 3GPP TS 38.331 v16.3.1: NR; Radio Resource Control (RRC); Protocol specification
3. 3GPP TS 23.501 v16.7.0: System architecture for the 5G System (5GS)
4. 3GPP TS 38.300 v16.4.0: NR; NR and NG-RAN Overall description; Stage-2
5. 3GPP TS 38.401 v16.4.0: NG-RAN; Architecture description

1. A method performed by a radio network node for handling communication in a wireless communications network, the method comprising:
transmitting system information, SI, comprising an association parameter associating a group identity, GID, with one or more networks in the SI.

2. The method according to claim 1, further comprising configuring a user equipment, UE, with one or more GIDs and/or one or more association parameters.

3. The method according to claim 1, wherein the association parameter comprises a bitmap.

4. The method according to claim 1, wherein the one or more networks comprises a stand-alone non-public network, SNPN, and the association parameter indicates that the SNPN supports several different GIDs.

5. The method according to claim 1, further comprising broadcasting a list of GIDs together with a list of Human Readable Group Names, HRGN, for the GIDs in a same system information block or separately from the GID.

6. A method performed by a user equipment, UE, for handling communication in a wireless communications network, the method comprising:
receiving, from a radio network node, system information, SI, comprising an association parameter associating a group identity, GID, with one or more networks in the SI.

7. The method according to claim 6, further comprising
configuring the UE with one or more GIDs and/or one or more association parameters.

8. The method according to claim 6, wherein the association parameter comprises a bitmap.

9. The method according to claim 6, wherein the one or more networks comprises a stand-alone non-public network, SNPN, and the association parameter indicates that the SNPN supports several different GIDs.

10. The method according to claim 6, further comprising
using the association parameter to access a network.

11. The method according to claim 10, wherein using the association parameter comprises selecting one of the networks the UE is allowed to access, based on the GID the UE is configured with.

12. The method according to claim 6, further comprising
receiving a list of GIDs together with a list of Human Readable Group Names, HRGN, for the GIDs in a same system information block or separately from the GID.

13. A radio network node for handling communication in a wireless communications network, the radio network node is comprising processing circuitry configured to
transmit system information, SI, comprising an association parameter associating a group identity, GID, with one or more networks in the SI.

14. The radio network node according to claim 13, wherein the radio network node is further configured to configure a user equipment, UE, with one or more GIDs and/or one or more association parameters.

15. The radio network node according to claim 13, wherein the association parameter comprises a bitmap.

16. The radio network node according to claim 13, wherein the one or more networks comprises a stand-alone non-public network, SNPN, and the association parameter indicates that the SNPN supports several different GIDs.

17. The radio network node according to claim 13, wherein the radio network node is further configured to broadcast a list of GIDs together with a list of Human Readable Group Names, HRGN, for the GIDs in a same system information block or separately from the GID.

18. A user equipment, UE, for handling communication in a wireless communications network, the UE is comprising a radio interface and processing circuitry configured to:
receive from a radio network node, system information, SI, comprising an association parameter associating a group identity, GID, with one or more networks in the SI.

19. The UE according to claim 18, wherein the UE is further configured to
configure the UE with one or more GIDs and/or one or more association parameters.

20. The UE according to claim 18, wherein the association parameter comprises a bitmap.

21. The UE according to claim 18, wherein the one or more networks comprises a stand-alone non-public network, SNPN, and the association parameter indicates that the SNPN supports several different GIDs.

22. The UE according to claim 18, wherein the UE is further configured to
use the association parameter to access a network.

23. The UE according to claim 22, wherein the UE is further configured to use the association parameter by selecting one of the networks the UE is allowed to access, based on the GID the UE is configured with.

24. The UE according to claim 18, wherein the UE is further configured to
receive a list of GIDs together with a list of Human Readable Group Names, HRGN, for the GIDs in a same system information block or separately from the GID.

25. A computer program product comprising instructions, which, when executed on at least one processor, cause the at least one processor to carry out the method according to claim 6, as performed by the UE.

26. A non-transitory computer-readable storage medium, having stored thereon a computer program product comprising instructions which, when executed on at least one processor, cause the at least one processor to carry out the method according to claim 6, as performed by the UE.
